(19) United States
(12) Patent Application Publication
(10) Pub. No.: US 2010/0051810 A1
(43) Pub. Date: Mar. 4, 2010

(54) MICROMECHANICAL COMPONENT AND CORRESPONDING PRODUCTION METHOD

(76) Inventors: Ingo Herrmann, Friolzheim (DE); Karl-Franz Reinhart, Weinsberg (DE); Daniel Herrmann, Tuebingen (DE); Frank Freund, Stuttgart (DE); Ando Feyh, Tamm (DE); Martin Eckardt, Stuttgart (DE)

Correspondence Address: KENYON & KENYON LLP, ONE BROADWAY, NEW YORK, NY, 10004, US

(21) Appl. No.: 12/541,745

(22) Filed: Aug. 14, 2009

(30) Foreign Application Priority Data
Aug. 28, 2008 (DE) 102008041674.6

(51) Int. Cl. G01J 5/00; B23K 31/02

(52) U.S. Cl. 250/338.1; 228/101; 228/226

(57) ABSTRACT

A micromechanical component and a corresponding production method. The micromechanical component includes a first component and a second component, with which the first component is connected by an alloy region; the first and second components enclosing a vacuum region or residual gas region, which is sealed by the alloy region.

### BACKGROUND INFORMATION

While applicable to any micromechanical component having a vacuum region or residual gas region, the present invention and the problem providing the basis of it are explained with regard to a micromechanical infrared sensor.

A sensor for detecting incoming infrared radiation is described in German Patent No. DE 10 2004 020 685, and is shown in FIGS. 2a and 2b.

This infrared sensor contains a vacuum region 104 that is enclosed by a sensor chip 102 and a cap chip 101, and that is formed by respective cavities of sensor chip 102 and of cap chip 101. An absorption layer 103, which at least partially covers a thermopile 106, is situated on a perforated diaphragm 105. Reference numeral 100 labels the infrared radiation coming in from above through cap chip 101, which causes the warming of absorption layer 103 and thus of the underlying contacts of the thermopile.

The resulting temperature difference between the warm contacts of the thermopile that are covered by absorption layer 105 and the cold contacts of the thermopile that are not covered by the absorption layer causes an electric voltage that is an index for the intensity of the infrared radiation.

Cap chip 101 is connected to sensor chip 102 by a wafer-level packaging (WLP), the connection region being sealed by a sealing glass layer 50. During production, sealing glass layer 50 is pressed onto the lower edge of cap chip 101, and subsequently a thermal connection to sensor chip 101 is produced.

For cost reasons and due to their structure, such wafer level packagings are particularly advantageous. However, what has proven disadvantageous in the present wafer level packagings based on sealing glass 50 is that residual gas components, which develop through the outgassing of organic residues of sealing glass 50 in the process and afterward, for example, cause a deterioration of the vacuum in vacuum region 104, which in turn, due to increased heat dissipation of the residual gas, reduces the infrared sensor's excess temperature, which is generated by the temperature radiation to be detected and thus degrades the infrared sensor's sensitivity.

As an indirect corrective for this problem, German Patent No. DE 10 2004 020 685 provided for an infrared-absorbing material having a simultaneous getter effect to be used as absorption layer 103, zirconium, for example. However, such a getter effect decreases over time.

### SUMMARY OF THE INVENTION

The micromechanical component according to the present invention, and the corresponding production method have the advantage that there is a reduced and well-manageable residual gas pressure in the vacuum region or in the residual gas region.

The use of alloy-forming metal/metal materials or metal/semiconductor materials as contact partners on the two components, e.g., circuit wafer and cap wafer, to connect the two components in the vacuum by applying pressure and temperature (eutectic bonding) permits an increased sensor sensitivity, a secure setting of the sensitivity during production (operating point in the pressure plateau of the sensitivity/pressure curve), and a better stability throughout the working life of the vacuum enclosure.

According to a preferred refinement, the alloy region features an Au-Si alloy.

According to an additional preferred refinement, the alloy region features a Ge-Al alloy.

According to another preferred refinement, the first component is a sensor wafer or sensor chip, and the second component is a cap wafer or cap chip.

According to another preferred refinement, at least one of the first and second components has a cavity that forms the vacuum region or residual gas region.

According to an additional preferred refinement, the micromechanical component is an infrared sensor device.

### BRIEF DESCRIPTION OF THE DRAWINGS

FIGS. 1a-1c show schematic cross-sectional representations to explain a method for producing a micromechanical infrared sensor device according to one specific embodiment of the present invention.

FIG. 2a and 2b show schematic sectional representations to explain a method for producing a micromechanical infrared sensor device described in German Patent No. DE 10 2004 020 685.

### DETAILED DESCRIPTION

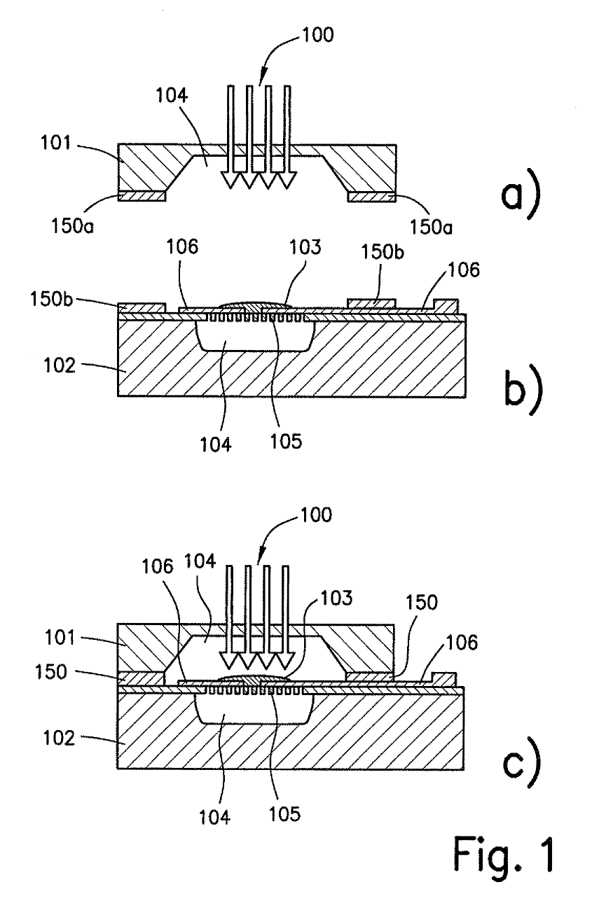

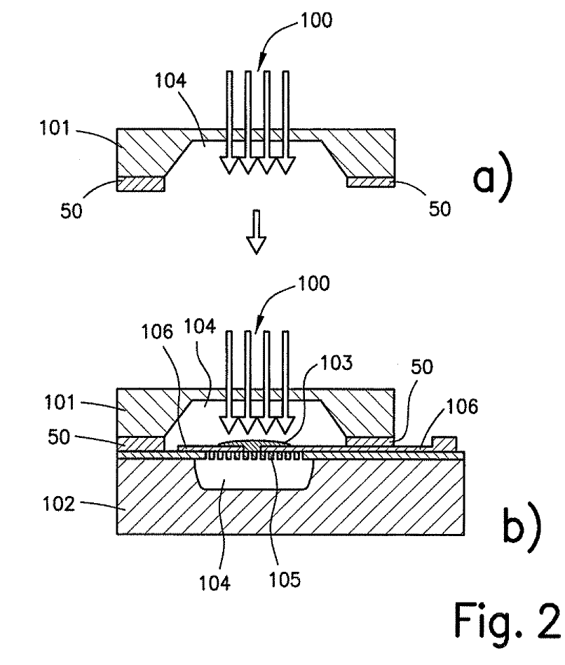

In FIGS. 1a-1c the same reference numerals label the same elements as they do in FIGS. 2a and 2b, and so a description is not repeated.

In contrast to FIGS. 2a and 2b, a gold layer 150a is deposited in the lower edge region of cap chip 101, whereas a corresponding silicon layer 150b is deposited on the connection region of sensor chip 102. To join cap chip 101 and sensor chip 102, both are brought into a defined vacuum atmosphere and subsequently joined using a temperature appropriate for a eutectic alloy of gold and silicon. After the cooling off, a vacuum of typically 0.1-1 mbar is provided in vacuum region 104, which vacuum is sealed effectively by eutectic Au-Si alloy 150. The residual gas pressure in vacuum region 104 is of the order of magnitude of the vacuum pressure applied during the sealing phase. In contrast to the known sealing glass, eutectic Au-Si alloy 150 does not result in any outgassing, which is why the vacuum in vacuum region 104 is stable, that is, is not subject to deterioration.

The two alloy partners 150a, 150b are expediently applied by deposition and subsequent patterning, by etching, for example. A masked depositing is also conceivable.

Although the present invention has been described above with reference to preferred exemplary embodiments, it is not limited thereto but rather is modifiable in many ways.

In particular, the present invention may be used not only for micromechanical infrared sensor devices, but for any micromechanical components having a capping.

In addition to the combination of Au and Si, in particular Al, Ge, or other metal/metal alloys or metal/semiconductor alloys that are free from outgassing are also possible alloy materials. In this context, one alloy material partner respectively exists on the cap edge before the eutectic bonding, and the respective other material partner exists on the future sealing surface of the sensor wafer.

Sensors in the form of infrared sensor devices having such a construction may be used as individual sensors for radiation temperature measurement and/or infrared gas sensor technology, for example, but also as an integrated remote or proximal infrared array for the detection of thermograms or living things in safety engineering or in vehicle night-vision systems.

While the above-mentioned specific embodiment describes the connection of a cap chip to a sensor chip, the present invention is also applicable to the connection of a cap wafer to a sensor wafer or to other capped components.

What is claimed is:

1. A micromechanical component comprising:
a first component; and
a second component, with which the first component is connected by an alloy region,
wherein the first and second components enclose a vacuum region or a residual gas region, which is sealed by the alloy region.

2. The micromechanical component according to claim 1, wherein the alloy region includes an Au-Si alloy.

3. The micromechanical component according to claim 1, wherein the alloy region includes a Ge-Al alloy.

4. The micromechanical component according to claim 1, wherein the first component includes a sensor wafer or sensor chip, and the second component includes a cap wafer or cap chip.

5. The micromechanical component according to claim 1, wherein one of the first and second components has a cavity that forms the vacuum region or residual gas region.

6. The micromechanical component according to claim 1, wherein the micromechanical component is an infrared sensor device.

7. A method for producing a micromechanical component, comprising:
thermally connecting a first component and a second component by an alloy region in a vacuum atmosphere or a residual gas atmosphere such that the first and second components enclose a vacuum region or a residual gas region that is sealed by the alloy region.

8. The method according to claim 7, wherein a first region having a first alloy partner is deposited on the first component and a second region having a second alloy partner is deposited on the second component before the connection is established, the first region having the first alloy partner and the second region having the second alloy partner being joined to establish the connection and forming the alloy region after the connection is established.

9. The method according to claim 7, wherein the alloy region includes an Au-Si alloy.

10. The method according to claim 7, wherein the alloy region includes a Ge-Al alloy.

11. The method according to claim 7, wherein the micromechanical component is an infrared sensor device.
